(19) United States
(12) Patent Application Publication
(10) Pub. No.: US 2026/0133804 A1
(43) Pub. Date: May 14, 2026

(54) PREFETCHER WITH IMPROVED STABILITY AND NOISE REDUCTION

(71) Applicant: SiFive, Inc., Santa Clara, CA (US)

(72) Inventors: Hung-Lun Chen, Zhubei (TW); Chih-Kai Yang, Taipei (TW); I-Cheng Cheng, Zhubei (TW)

(73) Assignee: SiFive, Inc., Santa Clara, CA (US)

(21) Appl. No.: 19/042,703

(22) Filed: Jan. 31, 2025

Related U.S. Application Data
(63) Continuation of application No. 18/946,582, filed on Nov. 13, 2024.

(51) Int. Cl. G06F 9/38; G06F 9/30

(52) U.S. Cl. CPC G06F 9/3806; G06F 9/30047; G06F 9/3856

(57) ABSTRACT

Prefetchers can have improved ability to make predictions in the presence of speculative execution. The prefetcher can maintain a training queue of addresses and can predict an address for a prefetch request based on the addresses in the training queue. The addresses in the training queue can be marked to distinguish addresses associated with speculatively-executed instructions from addresses associated with non-speculatively-executed instructions. If the speculation is determined to be incorrect, the prefetcher can remove the speculative addresses from the training queue, and if the speculation is determined to be correct, the prefetcher can remove the marking from the addresses associated with speculatively-executed instructions. The prefetcher can also pause prefetching during speculative execution.

### CROSS-REFERENCES TO RELATED APPLICATIONS

This application is a continuation of U.S. application No. Ser. No. 18/946,582, filed Nov. 13, 2024, the disclosure of which is incorporated herein by reference.

### TECHNICAL FIELD

This disclosure relates generally to microprocessors and in particular to a prefetcher with improved stability and noise reduction.

### BACKGROUND

Programmable processors incorporate circuits that fetch instructions from system memory (typically not in the same integrated circuit as the processor) and execute the instructions to operate on data. Some of the instructions can be “load” instructions, which instruct the microprocessor to fetch data to be operated upon from a specified address in system memory. Because the processor cannot execute instructions or operate on data until the instructions and data have been fetched, memory latency can be a limiting factor in processor performance. Accordingly, most processors include cache systems that can provide access to instructions and data with lower latency than system memory. For instance, instruction prefetcher circuits and instruction caches can fetch and store instructions in advance of execution, thereby hiding memory latency. Prefetching of instructions is based on assumptions about which instruction(s) will be executed in the near future. For instance, instructions are usually stored in system memory in program order, except for branches. Thus, addresses can be predicted to be sequential, except following a branch instruction, where there may be a jump to a new address. Some processors use branch prediction logic to predict which branch will be taken and prefetch instructions along the predicted branch. Data caches were originally developed to store recently used data for subsequent reuse, reducing the need to repeatedly read the same memory location. Some processors provide further performance enhancement by predictively prefetching data from memory into the cache. A data prefetcher can be implemented as a circuit that generates predictions of target addresses for future load instructions based on analysis of the target addresses of previous load instructions, using various algorithms that can identify a pattern in a sequence of addresses and make predictions based on the pattern. Numerous such algorithms are known, including detecting a pattern based on fixed stride, Markov models, or the like. Regardless of the particular prediction algorithm, a data prefetcher can fetch data from a predicted address into a cache, with the goal being to have data already present the cache when a load instruction targeting the address is received.

To the extent that a prefetcher can correctly predict future target addresses, memory latency can be hidden. Incorrect predictions, on the other hand, can adversely affect performance. For instance, an incorrect prediction may result in useful data or instructions being evicted from the cache in favor of data or instructions that will not be used.

### SUMMARY

In processors that speculatively execute instructions, the set of target addresses used by a prefetcher (e.g., data prefetcher or instruction prefetcher) to make address predictions can be “contaminated” by addresses that were not actually needed. For example, branch prediction logic in a processor may predict the outcome of a conditional branch instruction, and based on the predicted outcome, the processor can speculatively execute instructions along one path or the other following the branch. If the branch prediction is incorrect, the processor can revert its state to the branch point and resume execution along the correct path. However, the incorrect speculative execution may result in the prefetcher storing target addresses and/or making predictions based on addresses associated with the incorrect path (e.g., addresses of instructions along the incorrect path or addresses specified in speculatively-executed load instructions along the incorrect path). Such incorrect addresses result in contamination of the address history information used by the prefetcher to predict addresses with “noise” that increases the error rate of prefetcher address prediction, which in turn increases the likelihood of incorrect prefetches and/or eviction of useful data or instructions (i.e., data or instructions that the processor will soon operate on) from the cache in favor of other data or instructions that are not used.

Certain embodiments of the present invention relate to prefetchers with improved ability to make predictions in the presence of speculative execution. According to some embodiments, the prefetcher can maintain a training queue of addresses (e.g., target addresses or demand addresses associated with load instructions that have been executed in the case of a data prefetcher, or addresses of instructions that have been executed in the case of an instruction prefetcher) and can predict an address based on the addresses in the training queue. The addresses in the training queue can be marked (e.g., using a pointer or status bit) to distinguish addresses associated with speculatively-executed instructions from addresses associated with non-speculatively-executed instructions. If the speculation is determined to be incorrect, the prefetcher can remove the speculative addresses from the training queue, and if the speculation is determined to be correct, the prefetcher can remove the marking from the addresses associated with speculatively-executed load instructions (since their status is no longer speculative). In some embodiments, the prefetcher can also pause prefetching during speculative execution.

Some embodiments relate to a prefetcher for a processor. The prefetcher can include: a training queue configured to store a plurality of memory addresses; address prediction logic configured to generate a predicted address for a prefetch operation based on the memory addresses in the training queue; a request generator configured to generate a prefetch request based on the predicted address; and a queue manager. The queue manager can be configured to: receive memory addresses associated with instructions being executed by the processor (e.g., addresses of the instructions being executed and/or demand addresses associated with load instructions being executed) and add the received memory addresses to the training queue; receive speculative execution status information from a dispatch/retire unit of the processor; responsive to the speculative execution status information, mark one or more addresses in the training queue as corresponding to speculative execution of instructions; and remove the one or more marked addresses from the training queue in response to the speculative execution status information indicating an incorrect speculation.

The following detailed description, together with the accompanying drawings, will provide a better understanding of the nature and advantages of the claimed invention.

### BRIEF DESCRIPTION OF THE DRAWINGS

FIG. 1 shows a block diagram of a processing system according to some embodiments.

FIG. 2A shows a simplified graphical representation of instruction execution in a processor.

FIG. 2B shows a representation of addresses in a prefetcher training queue after a branch prediction error.

FIG. 3 shows a simplified block diagram of a prefetcher according to some embodiments.

FIG. 4 shows a flow diagram of a process that can be implemented in a prefetcher according to some embodiments.

FIGS. 5A-5C show representations of a prefetcher training queue at different stages of the instruction execution depicted in FIG. 2A according to some embodiments.

FIG. 6 shows a block diagram of a system for generation and manufacture of integrated circuits that can configure a processor according to some embodiments.

### DETAILED DESCRIPTION

The following description of exemplary embodiments of the invention is presented for the purpose of illustration and description. It is not intended to be exhaustive or to limit the claimed invention to the precise form described, and persons skilled in the art will appreciate that many modifications and variations are possible. The embodiments have been chosen and described in order to best explain the principles of the invention and its practical applications to thereby enable others skilled in the art to best make and use the invention in various embodiments and with various modifications as are suited to the particular use contemplated.

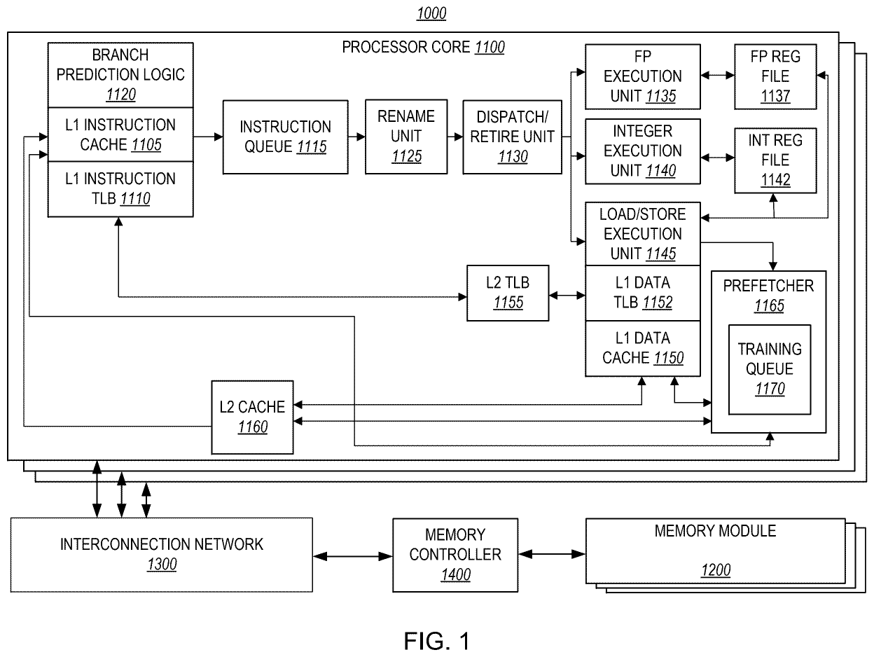

FIG. 1 shows a block diagram of a processing system 1000 according to some embodiments. Processing system 1000 can be implemented as an integrated circuit capable of decoding and executing instructions of an instruction set architecture (ISA) such as a RISC-V ISA. Processing system 1000 can have a pipelined architecture in which instructions can be executed speculatively and out-of-order. In various embodiments, processing system 1000 can be a compute device, a microprocessor, a microcontroller, an IP core, or the like.

Processing system 1000 includes at least one processor core 1100. Each processor core 1100 can be connected to one or more memory modules 1200 via an interconnection network 1300 and a memory controller 1400. Memory modules 1200 are sometimes referred to as external memory, main memory, backing store, coherent memory, or backing structure. The particular operation of external memory can be varied as desired without departing from the scope of this disclosure.

Each processor core 1100 can include a level-1 (L1) instruction cache 1105 which is associated with a L1 translation lookaside buffer (TLB) 1110 for virtual-to-physical address translation. An instruction queue 1115 buffers instructions fetched from the L1 instruction cache 1105 based on branch prediction logic 1120 and other fetch pipeline processing. Rename unit 1125 can perform register renaming on instructions from instruction queue 1115 to avoid false data dependencies. After renaming, a dispatch/retire unit 1130 can dispatch the instructions to appropriate execution units, including for example, a floating point execution unit 1135, an integer execution unit 1140, and a load/store execution unit 1145. Dispatch of instructions can occur in program order or out of program order as desired. Floating point (FP) execution unit 1135, which can execute floating-point arithmetic operations, can be allocated physical register files (FP register files) 1137, and integer execution unit 1140, which can execute integer arithmetic operations, can be allocated physical register files (INT register files 1142). Load/store execution unit 1145 handles instructions related to memory access, also referred to herein as “demand requests.” Demand requests can include data requests, load requests (requests to load data from an address in main memory into registers, such as registers in FP register files 1137 and/or INT register files 1142), store requests (requests to store data from registers, such as registers in FP register files 1137 and/or INT register files 1142 to an address in main memory), and the like. In some implementations, multiple load/store execution pipelines can be provided in one or more load/store execution units 1145. The particular number and configuration of execution units can be varied as desired without departing from the scope of this disclosure.

In some embodiments, processor core 1100 can include a hierarchical cache system for data and instructions. For instance, load/store execution unit 1145 can access an L1 data cache 1150 via an L1 data translation lookaside buffer (TLB) 1152, which is connected to a L2 TLB 1155. L1 data cache 1150 is connected to a L2 cache 1160, which is connected to the L1 instruction cache 1105. Upon receipt of a load request, load/store execution unit 1145 can send the request to L1 data TLB 1152, which can determine whether the data is already present i L1 data cache 1150. In the event of an L1 cache miss, L1 data TLB can forward the request to L2 TLB 1155 to determine whether the data is already present in L2 cache 1160. In the event of an L2 cache miss, L2 TLB 1155 can generate a read request to obtain the requested data from main memory. As shown in FIG. 1, L1 data cache 1150 can be separate from L1 instruction cache 1105, which can have its own L1 instruction TLB 1110. L2 TLB 1155 and L2 cache 1160 can be shared between instructions and data. Other cache system implementations can also be used without departing from the scope of this disclosure.

Load/store execution unit 1145 is connected to a prefetcher (or prefetcher circuit) 1165. In some implementations, prefetcher 1165 includes a data prefetcher that can initiate requests to transfer data from memory into cache (e.g., L1 data cache 1150) in anticipation of a future load request. In addition or instead, prefetcher 1165 can include an instruction prefetcher that can initiate requests to transfer instructions from memory into cache (e.g., L1 instruction cache 1105) in anticipation that the instructions will be executed (It should be noted that from the perspective of memory requests, both instructions and data are simply bits stored at particular memory locations.) Prefetcher 1165 can include one or more training queues 1170. Training queue 1170 can store multiple demand requests (e.g., load requests) that can be used as inputs to an address prediction algorithm implemented in prefetcher 1165. In some implementations, training queue 1170 includes a fixed number (N) of entries (e.g., 8 entries). Where prefetcher 1165 performs both data and instruction prefetch, separate training queues 1170 may be provided for data prefetch and instruction prefetch. Prefetcher 1165 can be connected to L1 data cache 1150, L1 instruction cache 1105, L2 cache 1160, and other caches, which can provide hit and miss indicators to prefetcher 1165 when a demand request hits or misses a cache, respectively.

Processing system 1000 and components thereof are illustrative and can include additional, fewer or different devices, entities, element, components, and the like which can be similarly or differently architected without departing from the scope of the present disclosure. Moreover, the illustrated devices, entities, element, and components can perform other functions without departing from the scope of the present disclosure. As an illustrative example, a data cache can include a data cache controller for operational control of the data cache.

In operation, for data prefetch, load/store execution unit 1145 can send or provide one or more demand requests to prefetcher 1165 and to the cache system (e.g., to L1 data TLB 1152) as appropriate. In some implementations, multiple demand requests can be provided in one clock cycle. In some embodiments, prefetcher 1165 can include a filter mechanism that determines whether a received demand request matches a demand request that is already stored in an entry in training queue 1170. The filtering mechanism can use one or more characteristics of a cache line, such as an address, to match demand requests. For instance, matching or duplicative received demand requests can be filtered out, and prefetcher 1165 can allocate an entry in training queue 1170 when a new or non-duplicative demand request is received. Such filtering can allow the size of training queue 1170 to be reduced without adversely affecting performance. Prefetcher 1165 can use training queue 1170, together with pattern detection logic, to predict one or more addresses that are likely to appear in subsequent demand requests and can use the predicted addresses to request prefetching of data from memory (e.g., into L1 cache) in advance of the demand request reaching load/store execution unit 1145. Similarly, for instruction prefetch, prefetcher 1165 can receive information from instruction queue 1115 indicating memory addresses of instructions that have been queued for execution. These addresses can be treated similarly to the demand addresses for load requests. As noted above, separate training queues can be maintained for data and instruction prefetch. To the extent the predictions of prefetcher 1165 are correct, prefetching of data can decrease the latency associated with executing load instructions.

In some embodiments, entries in training queue 1170 are allocated upon receipt of demand requests, without regard to program order. Similarly, prefetcher 1165 can issue prefetch requests without regard to the program order. Prefetcher 1165 can process actions as received without regard to the program order; in other words, prefetcher 1165 can implement out-of-order processing.

In embodiments described herein, a processor such as processor core 1100 can execute instructions speculatively. For instance, the instructions being executed in processor core 1100 can include conditional branch instructions, which specify that execution should continue along one of two alternative paths (sequences of instructions), depending on whether a condition is or is not met. Determining whether the condition is met may depend on an outcome of executing an instruction that precedes the conditional branch instruction. In a non-speculative processor, a processing pipeline would need to halt when a branch point is reached and wait until the condition is resolved, then resume execution along the correct branch. This can lead to unused processing cycles and reduced performance. In a processor core 1100 that supports speculative execution, branch prediction logic 1120 can predict which path should be taken at the branch point, prior to completion of the instruction that resolves the condition, and instruction queue 1115 can queue instructions from the predicted path for speculative execution, and the processing pipeline can continue to operate. Processor core 1100 (e.g., using logic in dispatch/retire unit 1130) can track which instructions are executed speculatively as well as which data is produced speculatively. Eventually, the condition is resolved, and processor core 1100 can determine whether the branch prediction was correct. If the branch prediction was incorrect, processor core 1100 can revert its internal state to a state corresponding to the branch point (the last non-speculative instruction in program order), flush in-flight instructions along the incorrect path from the execution pipeline, and resume execution along the correct path. If the branch prediction was correct, processor core 1100 can commit the speculatively-executed data to memory and continue execution along the predicted path in a non-speculative mode. To the extent branch predictions are correct, performance of the processor is enhanced.

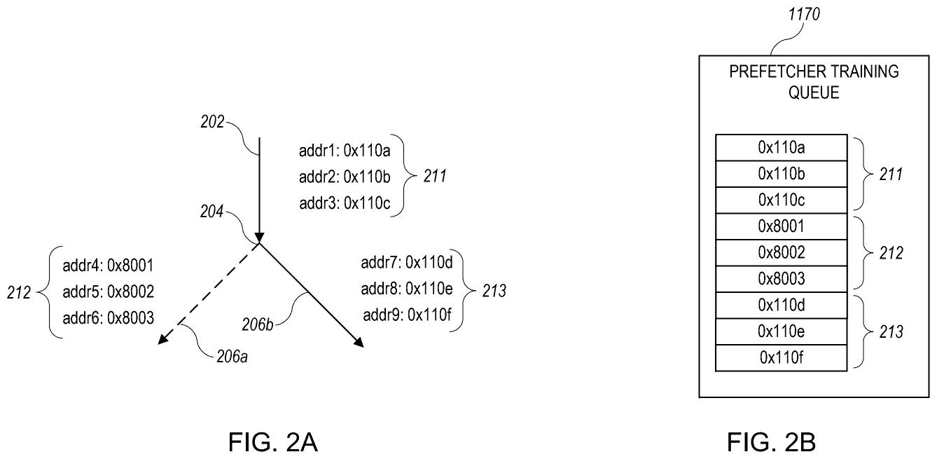

FIGS. 2A and 2B illustrate how speculative execution can lead to “noise” in prefetcher training queue 1170. FIG. 2A shows a simplified graphical representation of instruction execution in a processor, with a focus on memory addresses (e.g., instruction addresses or demand addresses associated with load instructions). An instruction sequence 202 is represented by an arrow. The order of instructions in sequence 202 can correspond to the order in which instructions are dispatched to execution units by dispatch/retire unit 1130, which may or may not correspond to the program order. Address sequence 211 represents a sequence of memory addresses associated with instruction sequence 202. At branch point 204, a conditional branch instruction is encountered. Depending on whether the condition is met, execution may proceed on either branch 206a or branch 206b. Address sequence 212 represents a sequence of addresses associated with branch 206a, and address sequence 213 represents a sequence of demand addresses associated with branch 206b. In operation, at branch point 204, branch prediction logic 1120 can predict that that branch 206a will be taken, and speculative execution can commence along branch 206a. If it is subsequently determined that the prediction was incorrect, processor core 1100 can revert to branch point 204 and resume execution along branch 206b.

As the instruction sequence is executed, addresses can be added to prefetcher training queue 1170. For instance, as each load request is executed, a demand address can be provided to prefetcher training queue 1170, or as each instruction is queued, an instruction address can be provided to prefetcher training queue 1170. FIG. 2B shows a representation of prefetcher training queue 1170 after a branch prediction error at branch point 204 that results in speculatively executing branch 206a when branch 206b was the correct branch. As shown, prefetcher training queue 1170 contains address sequence 211 (from instruction sequence 202), followed by address sequence 212 (from execution of incorrect branch 206a), followed by address sequence 213 (from execution of correct branch 206b). For purposes of predicting future addresses, address sequence 212 in this example constitutes noise (or contamination) in the prefetcher training data, i.e., incorrect information that may interfere with the ability of prefetcher 1165 to detect the correct pattern of addresses and accurately predict future addresses. Certain embodiments of the present invention provide circuits and techniques that can reduce or eliminate such noise in a prefetcher training queue.

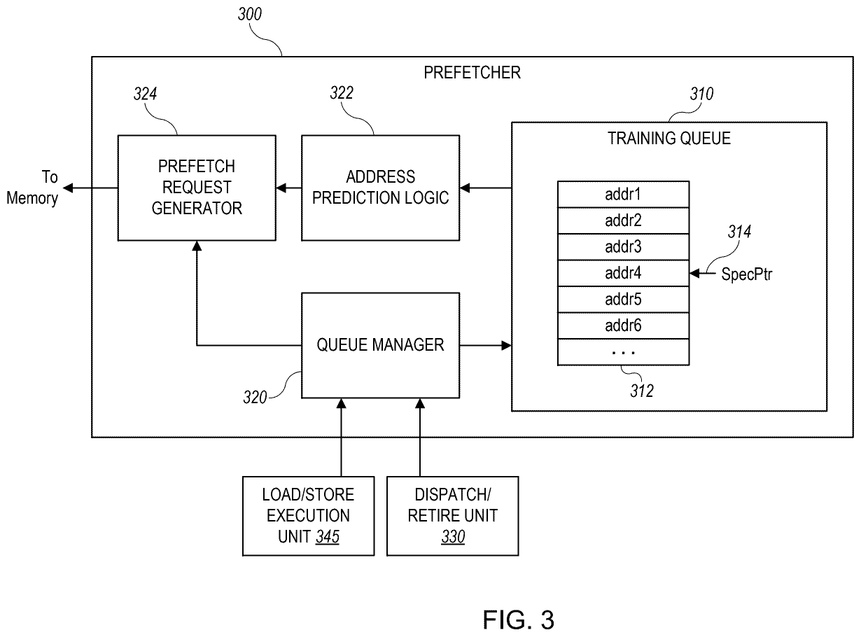

FIG. 3 shows a simplified block diagram of a prefetcher 300 (also referred to as a prefetch unit) according to some embodiments. Prefetcher 300 can be incorporated into various processors such as processor core 1100. Prefetcher 300 includes a training queue 310, a queue manager 320, address prediction logic 322, and a prefetch request generator 324. Prefetcher 300 can incorporate a data prefetcher and/or an instruction prefetcher.

Training queue 310 includes a memory structure 312 having a number of locations (or entries) that store addresses in order of receipt (e.g., instruction addresses or demand addresses associated with load instructions). Memory structure 312 can be, e.g., a circular buffer or the like. Memory structure 312 can have a fixed number of entries (e.g., 8 or 16 entries), and once capacity is reached, a new entry added to memory structure 312 can replace the oldest entry. As noted above, where both data and instruction prefetch are implemented, separate training queues 310 can be provided for data prefetch and instruction prefetch.

Address prediction logic 322 can include circuitry implementing a prediction algorithm that operates on entries in training queue 310 to generate a predicted address for a prefetch operation (which can be, e.g., data prefetch or instruction prefetch). In various embodiments, address prediction logic 322 can implement conventional or other algorithms. Examples include a fixed-stride detection algorithm, Markov models, or the like. Any prediction algorithm can be used without departing from the spirit and scope of this disclosure.

Prefetch request generator 324 can generate a request to prefetch data or instructions into a cache (e.g., L1 data cache 1150 or L1 instruction cache 1105 of processor core 1100) and send the request to an appropriate servicer (e.g., to L1 data TLB 1152 or L1 instruction TLB 1110 as described above). The implementation of an on-chip cache system can be modified as desired.

Queue manager 320 can manage training queue 310. For instance, queue manager 320 can receive load instructions from a load/store execution unit 345 (e.g., corresponding to load/store execution unit 1145 described above). Queue manager 320 can extract demand addresses and/or other information from the load instructions and add entries to training queue 310. Each entry can include the demand address and/or other information as desired. Queue manager 320 can also perform filtering (e.g., removal of duplicative demand addresses as described above) and other operations on received demand addresses as desired. For instruction prefetch, queue manager 320 can receive instruction addresses from instruction queue 1115 (shown in FIG. 1).

Queue manager 320 can also receive speculative execution status information from a dispatch/retire unit 330 (e.g., dispatch/retire unit 1130 of processor core 1100). The speculative execution status information can indicate whether a particular instruction is being executed speculatively (e.g., based on a branch prediction as described above). The speculative execution status information can also indicate when a branch condition has been resolved and whether the preceding speculative execution was correct (e.g., correct branch taken) or incorrect (e.g., incorrect branch taken).

When speculative execution begins, queue manager 320 can mark the entry in training queue 310 that corresponds to the first address associated with a speculatively-executed instruction. For instance, as shown in FIG. 3, a pointer 314 (also labeled as “SpecPtr”) can be used to identify the first “speculative” entry in memory structure 312. Since entries are added in order of receipt, it can be assumed that all subsequent entries are also speculative.

Subsequently, when the speculative execution status information provided by dispatch/retire unit indicates whether the preceding speculative execution was correct or incorrect, queue manager 320 can perform appropriate cleanup operations on training queue 310. For instance, if the speculative execution was incorrect, then the addresses in training queue 310 that were speculative can be removed. For instance, the entry in memory structure 312 identified by pointer 314 and all subsequent entries can be removed (e.g., cleared or marked as invalid), and pointer 314 can be reset to a null pointer, indicating that none of the entries in memory structure 312 are speculative. On the other hand, if the speculative execution was correct, then all addresses in training queue 310 can be retained as valid addresses, and pointer 314 can be reset to a null pointer, indicating that none of the entries in memory structure 312 are speculative.

In some embodiments, it may be desirable not to prefetch data or instructions during speculative execution. For instance, data or instructions prefetched during speculative execution of an incorrect branch may cause data or instructions associated with the correct execution path to be evicted from data caches, leading to slower execution when the correct path is resumed. Accordingly, queue manager 320 can pause prefetch operations for data and/or instructions during speculative execution. For instance, responsive to receiving an indication that an instruction is being executed speculatively, queue manager 320 can disable, or pause, prefetch request generator 324 (and address prediction logic 322 if desired). Once speculative instruction ends, queue manager 320 can enable prefetch request generator 324 (and address prediction logic 322 if desired).

It will be appreciated that prefetcher 300 is illustrative and that variations and modifications are possible. For example, techniques other than a pointer can be used to track which entries in the training queue are speculative (i.e., corresponding to speculatively executed instructions). In some embodiments, each entry in the training queue can include an associated “speculative status” bit indicating whether the entry is speculative or non-speculative (e.g., bit value 0 for speculative, 1 for non-speculative). The speculative status bit can be set appropriately when the entry is added to the training queue. When speculative execution is determined to be incorrect, the speculative status bits can be used to identify which entries should be cleared from the training queue; when speculative execution is determined to be correct, speculative status bits can be updated from the speculative value to the non-speculative value, with the entries being retained in the training queue.

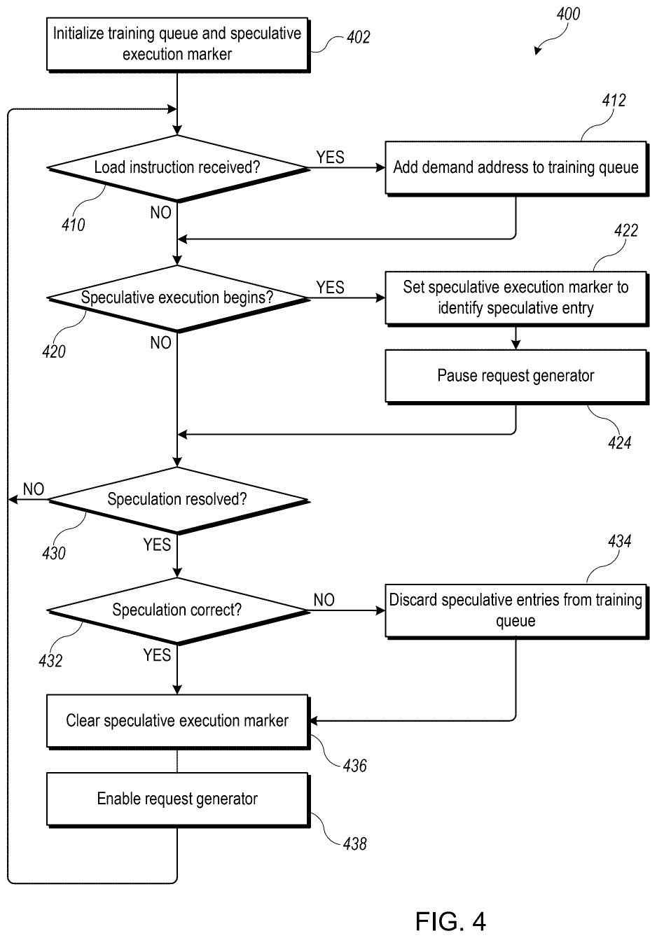

Further illustrating operation of a prefetch queue manager, FIG. 4 is a flow diagram of a process 400 that can be implemented in a prefetcher (e.g., in queue manager 320 of prefetcher 300) according to some embodiments. In this example, prefetcher 300 implements data prefetching; the process would be similar for instruction prefetching. Process 400 can begin, e.g., when program execution begins. At block 402, queue manager 320 can initialize training queue 310, e.g., by clearing all entries and initializing a speculative execution marker. In some embodiments, the speculative execution marker can be pointer 314 as described above. Other speculative execution markers can also be used, such as a speculative status bit associated with each entry in training queue 310. Thereafter, process 400 can enter a main processing loop that can continue, e.g., on a per-cycle basis, until program execution ends. During the main processing loop, queue manager 320 updates training queue 310 based on load instructions received from load/store execution unit 345 and speculative execution status information received from dispatch/retire unit 330.

The main processing loop can begin at block 410, where queue manager 320 can determine whether a load instruction has been received from load/store execution unit 345. If so then at block 412, queue manager 320 can extract a demand address from the load instruction and add the demand address to training queue 310. As noted above, in some embodiments adding of demand addresses to training queue 310 can include filtering and other operations.

At block 420, queue manager 320 can determine, based on speculative execution information received from dispatch/retire unit 330, whether speculative execution has begun. If so, then at block 422, queue manager 320 can set a speculative execution marker (e.g., pointer 314) to identify where speculative entries begin in training queue 310. At block 424, queue manager 320 can also pause prefetch request generator 324 so that prefetching is not performed during speculative execution.

At block 430, queue manager 320 can determine, based on speculative execution information received from dispatch/retire unit 330, whether speculative execution has been resolved. For instance, as described above, speculative execution can be resolved when the instructions that determine whether the condition of a conditional branch instruction was met, and the speculative execution can be resolved as either correct or incorrect. Such determinations can be made, e.g., in dispatch/retire unit 1130 of processor core 1100 described above. It should be understood that queue manager 320 can continue to add speculative entries to training queue 310 for as many cycles as speculative execution continues. If, at block 430, speculative execution has been resolved, then at block 432, queue manager 320 can determine, based on the speculative execution information received from dispatch/retire unit 330, whether the speculation was correct or incorrect. If the speculation was incorrect, then at block 434, queue manager 320 can discard any speculative entries from training queue 310. For instance, as described above, pointer 314 can be used to identify the point in training queue 310 where speculative execution began, and all entries following pointer 314 can be discarded (e.g., cleared or invalidated). Regardless of whether the speculation was correct, at block 436, the speculative execution marker can be cleared, e.g., by setting pointer 314 to the null pointer. At block 438, prefetch request generator 324 can be enabled, so that prefetching can resume.

It will be appreciated that process 400 is illustrative and that variations and modifications are possible. Blocks or operations described sequentially can be performed in parallel, and order of operations can be varied to the extent that logic permits. In some embodiments, process 400 can be implemented entirely in fixed-function logic circuitry. A similar process can be implemented to support instruction prefetch, with addresses of instructions received at the prefetcher being identified within the training queue as either speculative or non-speculative.

It should also be understood that, while process 400 is executing, prefetch requests can be generated at any time. For instance, address prediction logic 322 can produce a predicted address based on the entries in training queue 310 at that time, and prefetch request generator 324 can use the predicted address to generate a prefetch request. As noted above, prediction of addresses and generation of prefetch requests can be paused during speculative execution, which may avoid having prefetched data or instructions associated with the incorrect branch evict correct data or instructions from the L1 cache(s). In some embodiments where prefetch requests are not paused during speculative execution, address prediction logic 322 can use both speculative and non-speculative addresses in training queue 310 to predict addresses.

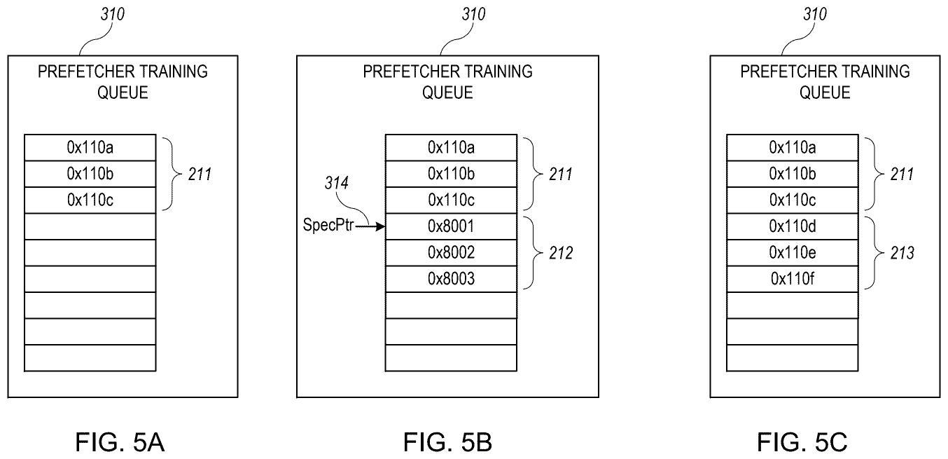

Operation of queue manager 320 can be further understood with reference to FIGS. 5A-5C, which show representations of prefetcher training queue 310 at different stages of the instruction execution depicted in FIG. 2A according to some embodiments. As in the description above, it is assumed that the processor executes instruction stream 202 shown in FIG. 2A to branch point 204, at which branch 206a is predicted when the correct branch is branch 206b. Accordingly, the processor executes instruction stream 202, then speculatively executes branch 206a, then reverts to branch point 204 and (non-speculatively) executes branch 206b.

FIG. 5A shows the state of training queue 310 when execution of instruction stream 202 reaches branch point 204. Address sequence 211 has been added to training queue 310. Thereafter, speculative execution of predicted branch 206a begins. FIG. 5B shows the state of training queue 310 after speculatively executing predicted branch 206a. Pointer 314 has been set to identify the first speculative entry (address 0x8001), and address sequence 212 has been added to training queue 310. Thereafter, the condition for branch point 204 is resolved, and it is determined that the speculative execution of branch 206a was incorrect. In response to receiving information that the speculative execution was incorrect, queue manager 320 can revert training queue 310 to the state shown in FIG. 5A by clearing address sequence 212 and resetting pointer 314 to the null pointer. Thereafter, (non-speculative) execution of correct branch 206b begins. FIG. 5C shows the state of training queue 310 after execution of correct branch 206b. Address sequence 213 has been added immediately following address sequence 211. Thus, training queue 310 includes only correct address information, which can improve the accuracy of subsequent address predictions (as compared to the “noisy” training queue 1170 shown in FIG. 2B).

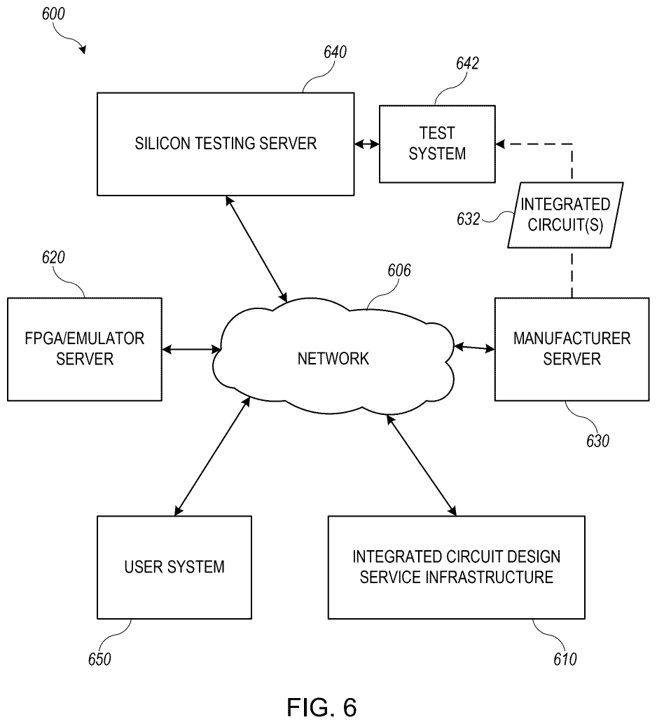

According to some embodiments, design of a processing system that includes a prefetcher of the kind described herein can be provided as a service. FIG. 6 shows a block diagram of a system 600 for generation and manufacture of integrated circuits that can configure a processor core including a prefetcher according to some embodiments (such as prefetcher 300) along with other system components (e.g., other components of processing system 1000 of FIG. 1). System 600 includes an integrated circuit design service infrastructure 610, a field programmable gate array (FPGA)/emulator server 620, a manufacturer server 630, a silicon testing server 640, and a user system 650 that communicate with each other via a network 606, which can be, e.g., the internet, a private network, a local network, or any other type of network. Infrastructure 610 and servers 620, 630, and 640 can be implemented using general-purpose computer systems of appropriate scale.

A user may utilize a web client or a scripting application program interface (API) client executing on user system 650 to command integrated circuit design service infrastructure 610 to automatically generate an integrated circuit design based on a set of design parameter values selected by the user for one or more template integrated circuit designs. In some implementations, the template integrated circuit designs may include one or more templates for a prefetcher. User system 650 can construct a design parameter data structure, e.g., as a JavaScript Object Notation (JSON) file based on user specifications or selections, and communicate the design parameter data structure to integrated circuit design service infrastructure 610 via network 606.

Integrated circuit design service infrastructure 610 can include a register-transfer level (RTL) service module configured to generate an RTL data structure for the integrated circuit based on a design parameters data structure. For example, the design parameter data structure can be processed to produce code in a hardware description language such as Scala or Chisel. The RTL service module can incorporate a Chisel compiler or the like to produce a flexible intermediate representation (FIR), which can be converted using a compiler such as the flexible intermediate representation for register-transfer level (FIRRTL) compiler to produce an RTL data structure (e.g., a Verilog file). RTL service module can also incorporate other design tools; for example, Diplomacy can facilitate generation of a parameterized protocol implementation such that multiple processor configurations can be generated from a single design with parameters specifying various features such as instruction set support (e.g., RV64, RV32 for RISC-V processors), bus and cache configurations, number of cores, prefetcher address prediction algorithms, size of the training queue, and so on.

In some implementations, integrated circuit design service infrastructure 610 can transmit the Verilog file to FPGA/emulation server 620 (e.g., via network 606). FPGA/emulation server 620 can perform testing of the design by running one or more FPGAs or other types of hardware or software emulators. For example, FPGA/emulation server 620 can perform a test using a field programmable gate array, programmed based on a field programmable gate array emulation data structure, to obtain an emulation result. Test results can be returned by the FPGA/emulation server 620 to integrated circuit design service infrastructure 610 and relayed in a useful format to the user, e.g., in a format that can be presented via a web client or a scripting API client executing on user system 650.

Integrated circuit design service infrastructure 610 can also facilitate the manufacture of integrated circuits using the integrated circuit design. For instance, integrated circuit design service infrastructure 610 can transmit a physical design specification to a manufacturer server 630 that is associated with a manufacturing facility capable of fabricating integrated circuits. In some implementations, the physical design specification can be in the form of a graphic data system (GDS) file, such as a GDSII file, which integrated circuit design service infrastructure 610 can generate from an RTL data structure in response to user approval of a particular design. Manufacturer server 630 can initiate manufacturing of the integrated circuit (e.g., using manufacturing equipment of the associated manufacturing facility). For example, manufacturer server 630 may host a foundry tape-out website that is configured to receive physical design specifications (such as a GDSII file or an open artwork system interchange standard (OASIS) file) and can schedule or otherwise facilitate fabrication of integrated circuits. In some implementations, integrated circuit design service infrastructure 610 supports multi-tenancy to allow multiple integrated circuit designs (e.g., from one or more users) to share fixed costs of manufacturing (e.g., reticle/mask generation, and/or shuttles wafer tests). For example, integrated circuit design service infrastructure 610 may use a fixed package (e.g., a quasi-standardized packaging) that is defined to reduce fixed costs and facilitate sharing of reticle/mask, wafer test, and other fixed manufacturing costs. A physical design specification generated by integrated circuit design service infrastructure 610 can include one or more physical designs from one or more respective physical design data structures in order to facilitate multi-tenancy manufacturing.

After receiving the physical design specification, the manufacturer associated with the manufacturer server 630 may fabricate and/or test integrated circuits based on the integrated circuit design. For example, the associated manufacturer (e.g., a foundry) may perform optical proximity correction (OPC) and similar post-tape-out/pre-production processing, fabricate a number of integrated circuit(s) 632, update integrated circuit design service infrastructure 610 (e.g., via communications with a controller or a web application server) periodically or asynchronously on the status of the manufacturing process, perform appropriate testing (e.g., wafer testing), and send integrated circuits 632 to a packaging house for packaging. A packaging house (not shown in FIG. 2) can receive the finished wafers or dice from the manufacturer and can test materials and update integrated circuit design service infrastructure 610 on the status of the packaging and delivery process periodically or asynchronously. In some implementations, status updates may be relayed to user system 650 when the user checks in using a web interface, and/or integrated circuit design service infrastructure 610 can notify the user of updates.

In some implementations, integrated circuit(s) 632 (e.g., physical chips) can be delivered (e.g., via mail) to a silicon testing service provider associated with a silicon testing server 640. In some implementations, resulting integrated circuit(s) 632 (e.g., physical chips) are installed in a test system 642 controlled by silicon testing server 640, and silicon testing server 640 can support remote operation of test system 642 via network 606. For example, silicon testing server 640 can establish an account that controls test system 642 to test integrated circuit(s) 632. Account login information can be sent to integrated circuit design service infrastructure 610 and relayed to user system 650. As another example, integrated circuit design service infrastructure 610 may be used to control testing of one or more integrated circuit(s) 632.

Integrated circuit design service infrastructure 610, FPGA/emulator server 620, manufacturing server 630, and silicon testing server 640 can be operated by the same entity or different entities as desired. In this example, the user can interact directly with integrated circuit design service infrastructure 610, which can serve as an intermediary to other services and service providers. Other implementations are also possible. For instance, a user can operate an integrated circuit design service infrastructure locally to generate graphic data system files, send the graphic data system files to a manufacturer, receive integrated circuits for testing, and perform tests locally. Alternatively, some operations may be performed locally while other operations are performed remotely.

In some embodiments, computer systems that facilitate generation of integrated circuits can include computer systems of generally conventional design. Such systems may include one or more processors to execute program code (e.g., general purpose microprocessors usable as a central processing unit (CPU) and/or special purpose processors such as graphics processors (GPUs) that may provide enhanced parallel processing capability); memory and other storage devices to store program code and data; user input devices (e.g., keyboards, pointing devices such as a mouse or touchpad, microphones); user output devices (e.g., display devices, speakers, printers); combined input/output devices (e.g., touchscreen displays); signal input/output ports; network communication interfaces (e.g., wired network interfaces such as Ethernet interfaces and/or wireless network communication interfaces such as Wi Fi); and so on. Computer systems can be implemented in a variety of form factors and with varying quantities of processor resources. For instance, user system 650 can be a consumer device such as a desktop computer, laptop computer, tablet computer, mobile device (e.g., smart phone), or the like. Integrated circuit design service infrastructure 610, FPGA/emulation server 620, manufacturer server 630 and silicon testing server 640 can be implemented using more powerful server systems or server farms and can be implemented using cloud-based services (e.g., virtual servers) rather than dedicated server hardware.

A non-transitory computer readable medium may store a circuit representation that, when processed by a computer, is used to program or manufacture an integrated circuit. For example, the circuit representation may describe the integrated circuit specified using a computer readable syntax. The computer readable syntax may specify the structure or function of the integrated circuit or a combination thereof. In various implementations, or at various stages of the design process, the circuit representation may take the form of a hardware description language (HDL) program, an RTL data structure, a flexible intermediate representation for register-transfer level (FIRRTL) data structure, a Graphic Design System II (GDSII) data structure, a netlist, or a combination thereof. In some implementations, the integrated circuit may take the form of a field-programmable gate array (FPGA), an application-specific integrated circuit (ASIC), a system on a chip (SoC), or some combination thereof. A computer may process the circuit representation in order to program or manufacture an integrated circuit, which may include programming an FPGA or manufacturing an ASIC or an SoC. In some implementations, the circuit representation may include a file that, when processed by a computer, may generate a new description of the integrated circuit. For example, the circuit representation can be written in a language such as Chisel, an HDL embedded in Scala, a statically typed general purpose programming language that supports both object-oriented programming and functional programming. A Chisel language program can be executed by a computer to produce a circuit representation expressed in a FIRRTL data structure. In some implementations, a design flow of processing steps may be utilized to process the circuit representation into one or more intermediate circuit representations, followed by a final circuit representation that is usable to program or manufacture an integrated circuit. In one example, a circuit representation in the form of a Chisel program may be stored on a non-transitory computer readable medium and may be processed by a computer to produce a FIRRTL circuit representation. The FIRRTL circuit representation may be processed by a computer to produce an RTL circuit representation. The RTL circuit representation may be processed by the computer to produce a netlist circuit representation. The netlist circuit representation may be processed by the computer to produce a GDSII circuit representation. The GDSII circuit representation may be processed by the computer to produce the integrated circuit. In another example, a circuit representation in the form of Verilog or VHDL may be stored on a non-transitory computer readable medium and may be processed by a computer to produce an RTL circuit representation. The RTL circuit representation may be processed by the computer to produce a netlist circuit representation. The netlist circuit representation may be processed by the computer to produce a GDSII circuit representation. The GDSII circuit representation may be processed by the computer to produce the integrated circuit. The foregoing steps may be executed by the same computer, different computers, or some combination thereof, depending on the implementation.

The foregoing examples illustrate how integrated circuits incorporating functionality and/or components described herein can be designed and manufactured. It should be understood that other processes and techniques can also be used.

While the invention has been described with reference to specific embodiments, those skilled in the art will appreciate that variations and modifications are possible. Management of a prefetcher training queue in the manner described herein can be applied in any prefetcher that uses memory addresses associated with recent activity in the processor (including but not limited to accessing data or instructions) to predict addresses of future memory requests, regardless of the details of prediction logic and of prefetch request generation and handling.

In some embodiments, the processor may speculatively execute through multiple branch points. Where this is the case, it may be desirable to provide multiple markers for entries, with a different marker associated with each branch. For instance, multiple speculative pointers can be maintained, or a multi-bit field can be used to track the speculative status of each entry in the training queue. As each branch is resolved, the makers can be updated and entries removed as appropriate.

Prefetchers of the kind described herein can be implemented in a variety of processor architectures, including instruction set architectures as well as hardware architectures. The processor may or may not support out-of-order execution of instructions. Where out-of-order execution is supported, the prefetcher can receive addresses in execution order or program order as desired. (For instance, demand addresses associated with load requests can be received in execution order; instruction addresses can be received in the same order as the instruction queue.)

While various circuits and components are described herein with reference to particular blocks, it is to be understood that these blocks are defined for convenience of description and are not intended to imply a particular physical arrangement of component parts. The blocks need not correspond to physically distinct components, and the same physical components can be used to implement aspects of multiple blocks. Components described as dedicated or fixed-function circuits can be configured to perform operations by providing a suitable arrangement of circuit components (e.g., logic gates, registers, switches, etc.); automated design tools can be used to generate appropriate arrangements of circuit components implementing operations described herein. Components described as processors, microprocessors, coprocessors or the like can be configured to perform operations on data by providing suitable program code. Various blocks might or might not be reconfigurable depending on how the initial configuration is obtained. Embodiments of the present invention can be realized in a variety of apparatus including electronic devices implemented using a combination of circuitry and software.

All processes described herein are also illustrative and can be modified. Operations can be performed in a different order from that described, to the extent that logic permits; operations described above may be omitted or combined; and operations not expressly described above may be added.

Computer programs incorporating features of the present invention that can be implemented using program code may be encoded and stored on various computer readable storage media; suitable media include magnetic disk or tape, optical storage media such as compact disk (CD) or DVD (digital versatile disk), flash memory, and other non-transitory media. In some instances, program code can be supplied via Internet download or other (transitory) signal transmission.

All numerical values and ranges provided herein are illustrative and may be modified. Unless otherwise indicated, drawings should be understood as schematic and not to scale.

Accordingly, although the invention has been described with respect to specific embodiments, it will be appreciated that the invention is intended to cover all modifications and equivalents within the scope of the following claims.

1. (canceled)

2. A method comprising:
receiving at an integrated circuit design computer system, via a network interface, an instruction to build an integrated circuit that includes a prefetcher, the instruction including a design parameter data structure specifying design parameters of the integrated circuit;
responsive to the instruction and the design parameter data structure, generating, using the integrated circuit design computer system, a register-transfer level (RTL) data structure for an integrated circuit that includes the prefetcher;
responsive to the instruction, automatically generating, using the integrated circuit design computer system, a physical design specification for the integrated circuit based on the RTL data structure, the physical design specification including specifications for logic circuits implementing:
a training queue configured to store a plurality of memory addresses;
address prediction logic configured to generate a predicted address for a prefetch operation based on the memory addresses in the training queue;
a request generator configured to generate a prefetch request based on the predicted address; and
a queue manager configured to:
receive memory addresses associated with instructions being executed and add the received memory addresses to the training queue;
receive speculative execution status information for the instructions being executed;
responsive to the speculative execution status information, mark one or more addresses in the training queue as corresponding to speculative execution of instructions; and
remove the one or more marked addresses from the training queue in response to the speculative execution status information indicating an incorrect speculation; and
transmitting, storing, or displaying the physical design specification.

3. The method of claim 2 further comprising:
transmitting the physical design specification to a manufacturer server,
wherein the manufacturer server fabricates at least one integrated circuit based on the physical design specification.

4. The method of claim 3 further comprising:
providing the at least one integrated circuit to a testing system,
wherein the testing system performs tests on the at least one integrated circuit.

5. The method of claim 2 wherein the physical design specification is generated such that:
the training queue comprises a buffer having a plurality of entries, each entry storing an address; and
the queue manager is further configured to use a pointer to mark which addresses in the training queue correspond to speculative execution of instructions.

6. The method of claim 2 wherein the physical design specification is generated such that the queue manager is further configured to remove the mark from the one or more marked addresses in response to the speculative execution status information indicating an incorrect speculation.

7. The method of claim 2 wherein the physical design specification is generated such that the memory addresses include demand addresses associated with load instructions being executed.

8. A method comprising:
receiving at an integrated circuit design computer system, via a network interface, an instruction to build an integrated circuit that includes a prefetcher, the instruction including a design parameter data structure specifying design parameters of the integrated circuit;
responsive to the instruction and the design parameter data structure, generating, using the integrated circuit design computer system, a register-transfer level (RTL) data structure for an integrated circuit that includes the prefetcher;
responsive to the instruction, automatically generating, using the integrated circuit design computer system, a physical design specification for the integrated circuit based on the RTL data structure, the physical design specification including specifications for logic circuits implementing:
a dispatch/retire unit configured to dispatch instructions for execution and to track completion status of instructions, the dispatch/retire unit further configured to dispatch instructions speculatively and to track which instructions are dispatched speculatively;
a cache system to cache data from a main memory; and
the prefetcher, wherein the prefetcher includes:
a training queue configured to store a plurality of memory addresses;
address prediction logic configured to generate a predicted address for a prefetch operation based on the memory addresses in the training queue;
a request generator configured to generate a prefetch request based on the predicted address; and
a queue manager configured to:
receive memory addresses associated with instructions being executed and add the received memory addresses to the training queue;
receive speculative execution status information from the dispatch/retire unit;
responsive to the speculative execution status information, mark one or more addresses in the training queue as corresponding to speculative execution of instructions; and
remove the one or more marked addresses from the training queue in response to the speculative execution status information indicating an incorrect speculation; and
transmitting, storing, or displaying the physical design specification.

9. The method of claim 8 wherein the physical design specification is generated such that the queue manager is further configured to pause the request generator while the speculative execution status information indicates that speculative execution is occurring and to enable the request generator when the speculative execution status information indicates that speculative execution is not occurring.

10. The method of claim 8 wherein the physical design specification is generated such that the training queue comprises a buffer having a plurality of entries, each entry storing an address, and wherein the queue manager is further configured to use a pointer to mark which addresses in the training queue correspond to speculative execution of instructions.

11. The method of claim 8 wherein the physical design specification is generated such that the queue manager is further configured to remove the mark from the one or more marked addresses in response to the speculative execution status information indicating an incorrect speculation.

12. The method of claim 8 wherein the physical design specification is generated such that the memory addresses include addresses of the instructions being executed.

13. The method of claim 8 wherein the physical design specification further includes specifications for logic circuits implementing:
a load/store unit configured to receive and execute load and store instructions from the dispatch/retire unit and to obtain data from the main memory in response to a load instruction,
wherein the memory addresses include demand addresses associated with load instructions being executed in the load/store unit.

14. The method of claim 13 wherein the specifications for logic circuits implementing the cache system include specifications for logic circuits implementing a level-1 data cache and configuring the cache system to store data responsive to the prefetch request in the level-1 data cache.

15. The method of claim 8 wherein the physical design specification is generated such that the dispatch/retire unit is configured to dispatch instructions for execution out of order.

16. The method of claim 8 wherein the physical design specification is generated such that the queue manager is further configured to add the received memory addresses to the training queue in order of receipt.

17. A system comprising:
a network interface;
a memory; and
one or more processors coupled to the network interface and the memory, the one or more processors being configured to:
receive, via the network interface, an instruction to build an integrated circuit that includes a prefetcher, the instruction including a design parameter data structure specifying design parameters of the integrated circuit;
generate, responsive to the instruction and the design parameter data structure, a register-transfer level (RTL) data structure for an integrated circuit that includes the prefetcher;
generate, responsive to the instruction, a physical design specification for the integrated circuit based on the RTL data structure, the physical design specification including specifications for logic circuits implementing:
a training queue configured to store a plurality of memory addresses;
address prediction logic configured to generate a predicted address for a prefetch operation based on the memory addresses in the training queue;
a request generator configured to generate a prefetch request based on the predicted address; and
a queue manager configured to:
receive memory addresses associated with instructions being executed and add the received memory addresses to the training queue;
receive speculative execution status information for the instructions being executed;
responsive to the speculative execution status information, mark one or more addresses in the training queue as corresponding to speculative execution of instructions; and
remove the one or more marked addresses from the training queue in response to the speculative execution status information indicating an incorrect speculation; and
transmit, store, or display the physical design specification.

18. The system of claim 17, wherein the one or more processors are further configured to transmit the physical design specification to a manufacturer server that fabricates at least one integrated circuit based on the physical design specification.

19. The system of claim 17 wherein the one or more processors are further configured such that the physical design specification specifies that:
the training queue comprises a buffer having a plurality of entries, each entry storing an address; and
the queue manager is further configured to use a pointer to mark which addresses in the training queue correspond to speculative execution of instructions.

20. The system of claim 17 wherein the one or more processors are further configured such that the physical design specification specifies that the queue manager is further configured to remove the mark from the one or more marked addresses in response to the speculative execution status information indicating an incorrect speculation.

21. The system of claim 17 wherein the one or more processors are further configured such that the physical design specification specifies that the memory addresses include demand addresses associated with load instructions being executed.
